(19) United States
(12) Patent Application Publication
(10) Pub. No.: US 2005/0086081 A1
(43) Pub. Date: Apr. 21, 2005

(54) Electronic drug prescription system

(76) Inventor: George A. Brock-Fisher, Andover, MA (US)

Correspondence Address: ATL ULTRASOUND, P.O. BOX 3003, 22100 BOTHELL EVERETT HIGHWAY, BOTHELL, WA, 98041-3003, US

(21) Appl. No.: 10/958,307

(22) Filed: Oct. 4, 2004

Related U.S. Application Data
(60) Provisional application No. 60/511,892, filed on Oct. 16, 2003.

(51) Int. Cl. G06F 17/60

(52) U.S. Cl. 705/2

(57) ABSTRACT

The present invention provides a system and method for an electronic system for the prescribing and dispensing of drug prescriptions that is email-like system or specifically utilizes email and/or the Internet for a prescription/refill/renew entry application running on a computer system at a prescriber's office, a clearinghouse computer system that is responsible for authenticating requests as having come from a certified, licensed, or otherwise qualified source, and redirecting the prescriptions electronically to a drug provider or to a provider chosen by one the clearinghouse system, prescriber, and patient. The system provides optional authorization for drug prescriptions by an insurer, if the patient has prescription drug coverage. Further, all transmissions are encrypted to preclude unauthorized access and access is further controlled to ensure patient privacy.

This invention claims the benefit of Provisional U.S. Patent Application Ser. No. 60/511,892, filed Oct. 16, 2003.

The present invention relates to prescription and delivery of drugs prescribed. More particularly, the present invention relates to a system and method for the electronic prescribing and dispensing of drug prescriptions to a patient that authenticates the drug prescriber while protecting patients' privacy rights.

Today, despite the advance of electronic communications in other areas, the prescribing of prescription drugs by prescribers still follows a very manual and therefore slow as well as error-prone process. Typically, a patient requests a prescription from a prescriber. This may occur at an office visit, or over the telephone, in the cases of minor ailments or refills of existing medications. The prescriber then either manually writes a prescription on a form, or telephones the supplying pharmacy directly with the prescription information. Either way, there are many opportunities between the time when the initial request is made and when the patient receives the prescribed medicine for error in interpreting what was written or said. Additionally, there are many chances for delay to occur in the actual delivery of the drugs to the patient, as the pharmacist may need to call the prescriber to confirm the prescription, and may even need to contact the patient's insurance carrier to obtain authorization because the particular drug is not on the carrier's formulary or the amount exceeds coverage limits. Further, paper documents are easily lost.

There are several possible inefficiencies in the current prescription drug delivery system. The present approach does not facilitate coordination between physician, drug provider, insurance provider, and patient/caregiver. Even when the drug provided and the prescribing physician are collocated, a paper form is filled out and hand-carried between them by the patient/caregiver with all the attendant opportunities for loss and misinterpretation. Not only are these problems inherent in the current procedure for prescription drug delivery, the lack of any real-time communication between physician and drug provider means that there is no way for the prescribing physician to ascertain whether a drug is even available at the drug provider to be delivered to a patient/caregiver. Either the patient/caregiver waits for the drug to be supplied to the drug provider by a supplier or the patient/caregiver is directed to another drug provider who may or may not have the prescribed drug in stock.

Another problem arises with specialty drug refills. There is no system in place for anticipating refills of drugs that are not normally carried by a drug provider either because of cost or low usage of the drug. And, then it falls to the patient/caregiver to anticipate running out of such a drug and ordering a resupply well in advance so that the drug provider can obtain the drug.

Finally, even with computerized record-keeping systems pharmacies can deliver the wrong drug due to human error introduced by the manually intensive prior art drug delivery procedure. And, it falls to the patient/caregiver to perform quality assurance on the accuracy of the delivered prescription drug.

The present invention provides a system and method for an electronic system for the prescribing and dispensing of drug prescriptions. A preferred embodiment comprises the following:
1. a system and method specifically utilizing a network, such as the Internet, for a new/refill/renew/modify entry prescription application running on a prescription entry subsystem;
2. an optional clearinghouse subsystem that is responsible for authenticating requests as having come from a certified, licensed, or otherwise qualified source, and redirecting the prescriptions electronically to a specified drug provider or to a provider chosen by the clearinghouse system, the clearinghouse system having authenticated the drug provider and authorized the prescription by an insurer, if any;
3. a drug provider subsystem specifically utilizing a network, such as the Internet, for receiving and filling/refilling/renewing/modifying prescriptions cleared by the clearinghouse, or alternatively, cleared by the drug provider in the case of no clearinghouse subsystem.

A prescriber or patient/caregiver enters the new or refill or renewal request for a drug prescription into a prescription entry subsystem using the method of the present invention and the drug prescription is first checked for adverse interactions with other drugs being taken by a patient, for availability from a drug provider subsystem, and if no adverse reactions are found is then electronically transmitted to an authenticating clearinghouse subsystem or directly to a drug provider subsystem for authentication. In the case of a new prescription, detailed patient information is also entered and in the case of a renewal and/or refill the patient is identified. Updates can be made at any time to both patient and prescription information using the same procedure and system of the present invention. Once entered, information is transmitted to the clearing house subsystem or directly to a drug provider subsystem and once validated is forwarded to a drug provider subsystem, or it is stored by the drug provider subsystem in a database in the case of no clearinghouse subsystem. Note that either the original information entered or a processed version thereof can be forwarded by the clearinghouse subsystem to the drug provider or directly to the drug provider subsystem by the drug prescription subsystem.

In order to ensure integrity of data and patient privacy, all transmission are encrypted at their source and decrypted at their destination. Only authorized user is permitted to access the data and protections, such as passwords, are changed on a regular basis.

The foregoing and other features and advantages of the present invention will be apparent from the following, more detailed description of preferred embodiments as illustrated in the accompanying drawings in which reference numerals refer to the same parts throughout the various views.

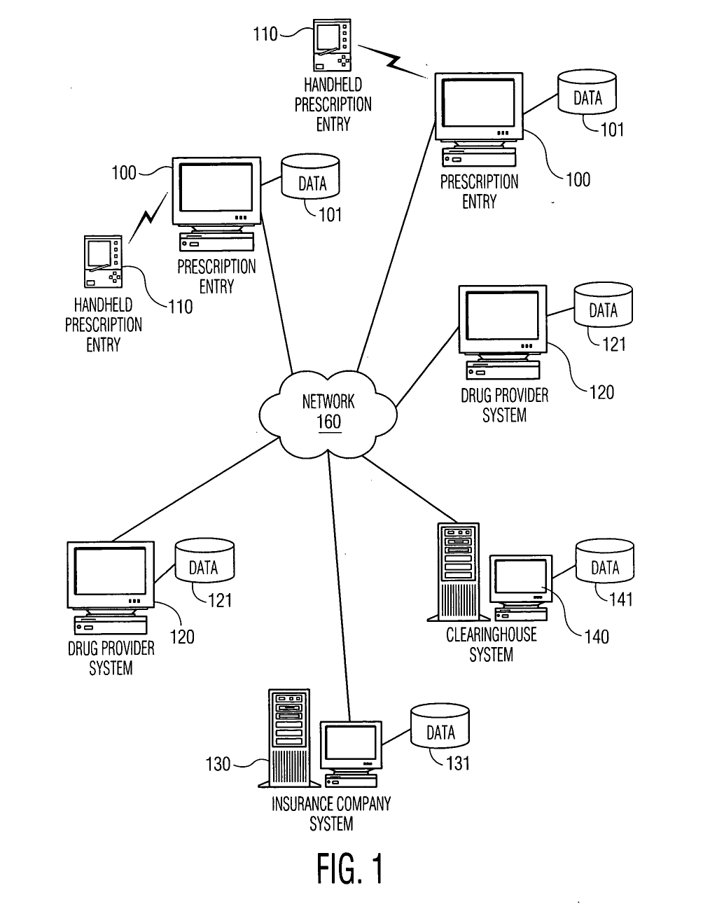

FIG. 1 illustrates an exemplary network in which systems and methods, consistent with the present invention may be implemented;

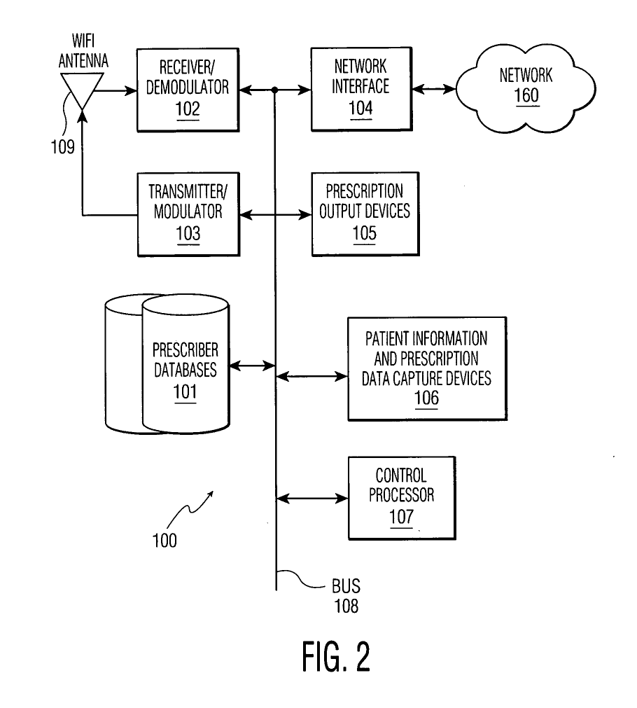

FIG. 2 illustrates exemplary components of a prescription entry subsystem consistent with the present invention;

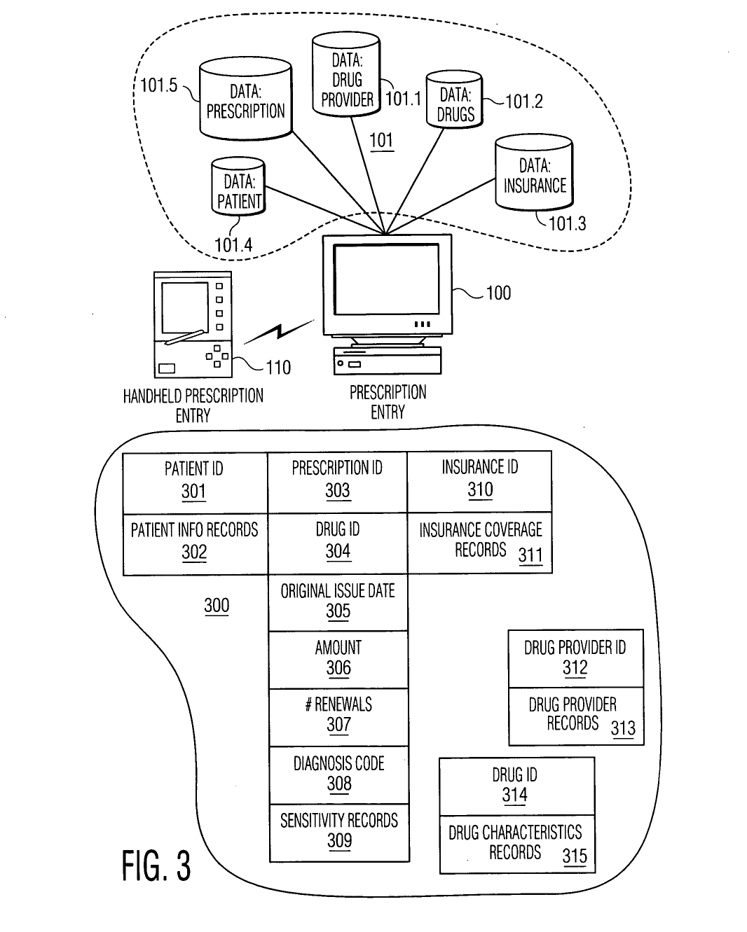

FIG. 3 illustrates an exemplary database stored in a prescription entry subsystem of FIG. 2 consistent with the present invention;

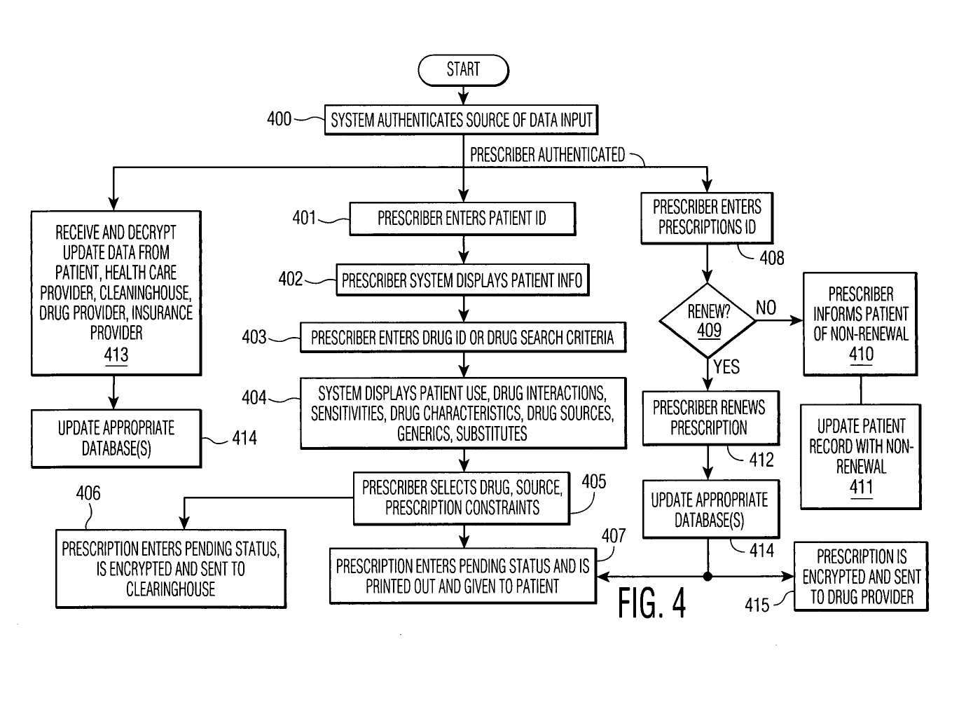

FIG. 4 is a flow chart that illustrates exemplary system processing of a prescription entry subsystem consistent with the present invention.

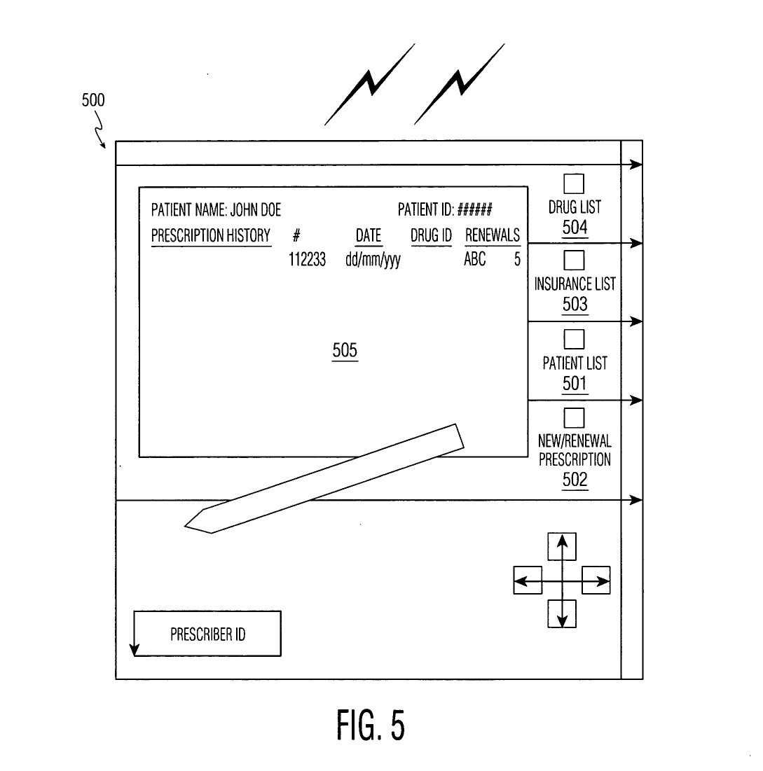

FIG. 5 illustrates an exemplary configuration of a handheld drug prescription entry device consistent with the present invention;

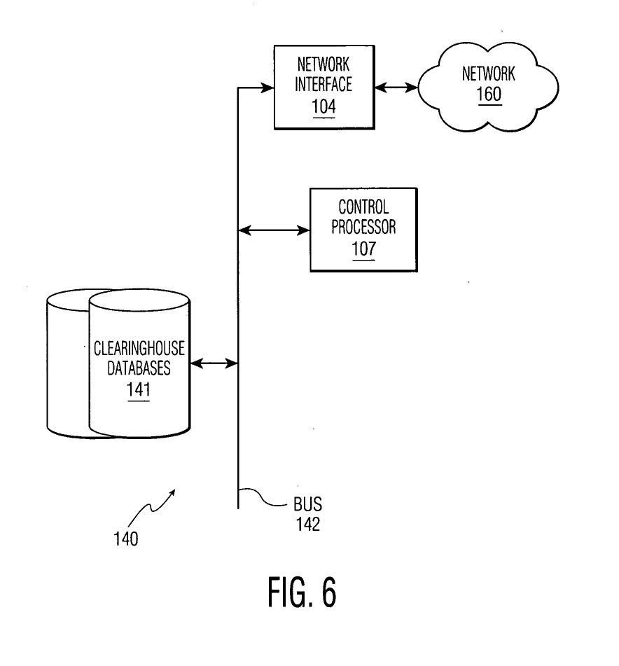

FIG. 6 illustrates exemplary components of a clearinghouse subsystem consistent with the present invention;

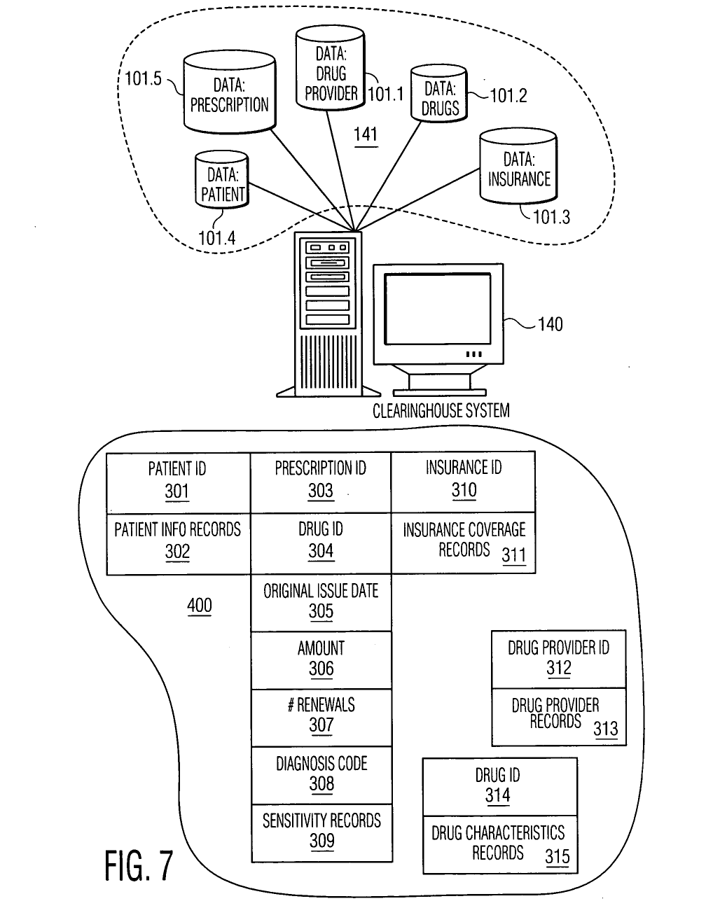

FIG. 7 illustrates an exemplary database stored in clearinghouse subsystem of FIG. 5 consistent with the present invention;

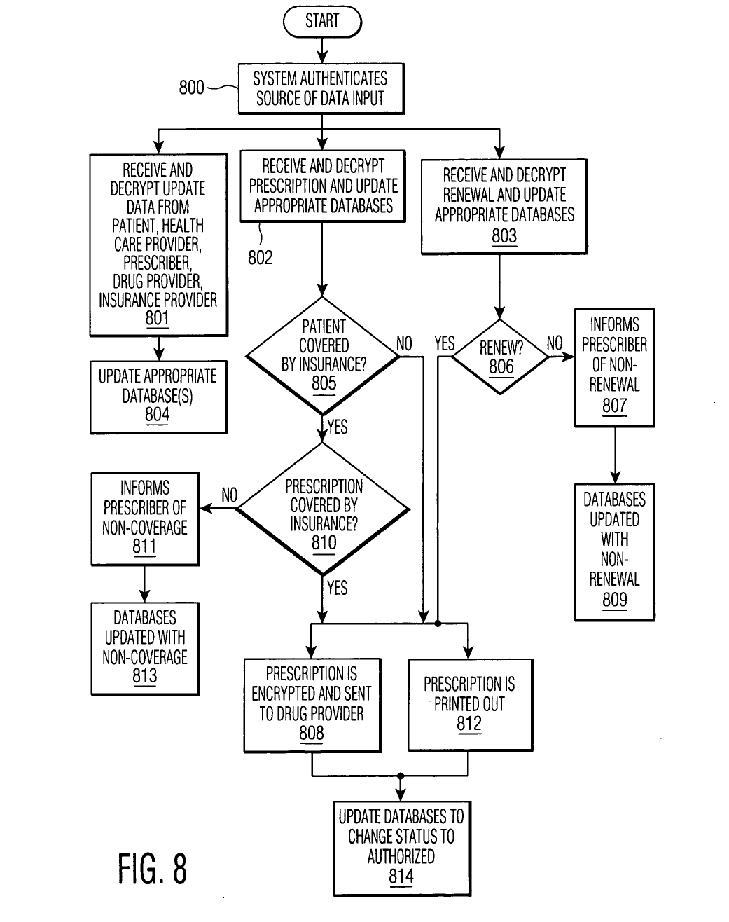

FIG. 8 is a flow chart that illustrates exemplary system processing of a clearinghouse subsystem consistent with the present invention.

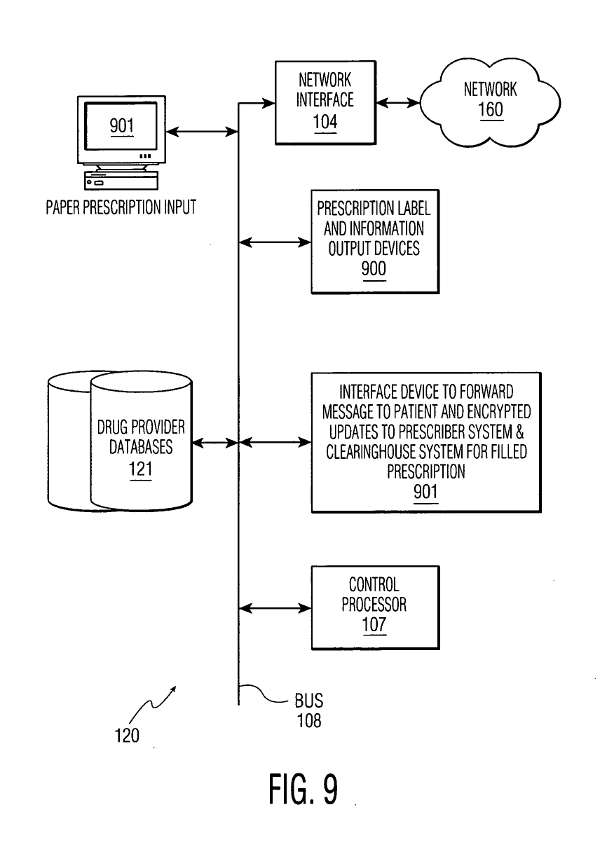

FIG. 9 illustrates exemplary components of a drug provider subsystem consistent with the present invention;

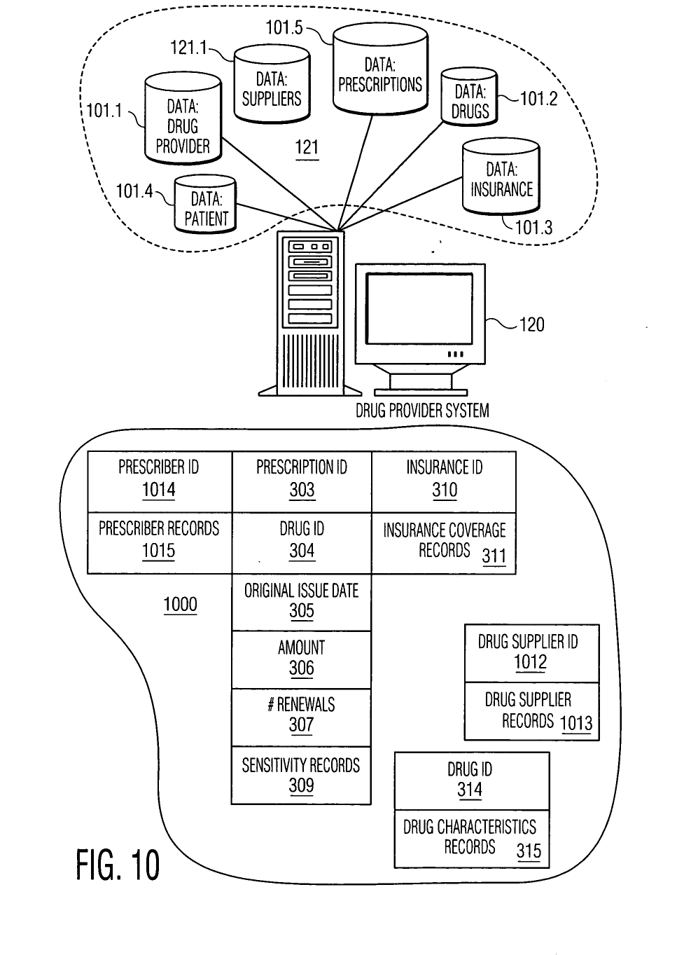

FIG. 10 illustrates an exemplary database stored in drug provider subsystem of FIG. 9 consistent with the present invention; and

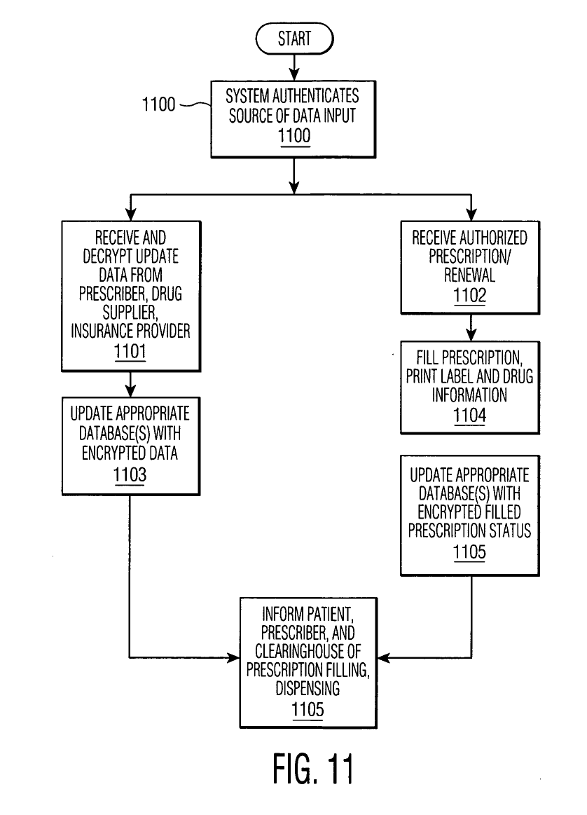

FIG. 11 is a flow chart that illustrates exemplary system processing of a drug provider subsystem consistent with the present invention.

It is to be understood by persons of ordinary skill in the art that the following descriptions are provided for purposes of illustration and not for limitation. An artisan understands that there are many variations that lie within the spirit of the invention and the scope of the appended claims. Unnecessary detail of known functions and operations may be omitted from the current description so as not to obscure the present invention.

According to one aspect of the invention, an electronic network provides end-to-end networked functionality for the prescribing, authenticating, and dispensing of drug prescriptions. An embodiment of the system includes some at least one of the following elements:
1. A networked electronic prescription entry application running on a computer based prescription entry system at a prescriber's location, e.g., doctor's office, that can optionally authorize a drug prescription by a patient's insurer (if any) and forwards the drug prescription to a clearinghouse subsystem or a drug provider subsystem;
2. An optional intermediary clearinghouse computer subsystem which is responsible for authenticating requests as having come from a certified, licensed, or otherwise qualified source, authorizing the drug prescription by an insurer (if the patient is insured) and redirecting the prescriptions electronically to a specified drug provider subsystem or other drug provider (pharmacy, etc.) that is also authenticated as a certified, licensed, or otherwise qualified provider;
3. A similar networked electronic drug provider subsystem to the prescription entry subsystem is at the drug provider, since prescriptions can still be in written form. This could be a local drugstore, or a mail-order drug provider.

It will be understood by those skilled in the art that the following descriptions of databases are meant to be illustrative only and are not presented in any limiting sense. In particular, any discussion of identifiers or IDs is merely for purposes of explanation and is not meant to limit the described database to identifiers included in the discussion. Other identifiers are not only possible but are likely to be included by one skilled in the art to make the access and storing of information in the databases more efficient, and the discussion by no means exhaustive of possible database designs.

FIG. 1 illustrates an exemplary network in which systems and methods, consistent with the present invention may operate to capture a drug prescription 100 110 entered by a prescriber using a computer system or other capture device at the prescriber's location, store the captured information in a local database 101 and transmit the encrypted captured prescription over a network 160, such as the Internet, to another location, such as a clearinghouse subsystem 140 for authentication and authorization or directly to a drug provider subsystem 120, for decryption, authentication and dispensing.

FIG. 2 illustrates exemplary components of a prescription entry subsystem consistent with the present invention in which patient and prescription data is captured 106 at the prescriber's location 100 110, e.g., doctor's office, a hospital, a hospice, a home, a clinic, a dentist's office or other health care facility. A control processor 107 authenticates the prescriber, stores the captured data in prescriber databases 101, encrypts the prescription and either transmits the encrypted prescription via the network interface 104 over the network 160 (e.g., the Internet) to a clearinghouse system 140 or directly to a drug provider system 120. If the prescriber is mobile and uses a personal digital assistant or other portable input device that uses a wireless WIFI interface 109, the input is received and demodulated 102 and then stored by the control processor 107 in the prescriber databases 101 prior to encrypting and sending the prescription over the network 160 via the network interface 104. Output to the wireless device is via transmitter/modulator 103 as controlled by the control processor 107. For further security, information may be encrypted prior to being stored in local databases 101.

FIG. 3 illustrates exemplary databases 101 stored in a prescription entry subsystem of FIG. 2 consistent with the present invention. The prescriber databases comprise:
patient database 101.4 having records identified by patient ID 301 and storing patient information 302;
drugs database 101.2 having records identified by drug ID and storing drug characteristics information 315;
insurance database 101.3 having records identified by insurance ID storing insurance coverage records 311;
prescription database 101.5 having records identified by prescription ID storing prescription details;
and drug provider (dispenser) 101.1 having records identified by prescription ID storing drug provider records.
   For security purposes, only authorized users are allowed access to these databases and access mechanisms are regularly changed to further protect data from unauthorized user access.

FIG. 4 is a flow chart that illustrates exemplary system processing of a prescription entry subsystem consistent with the present invention. While only three processing flows are illustrated this is not to be construed as limiting as the three flows are presented as examples only, and not in any limiting sense. The processing flows accomplished by a prescription entry subsystem comprise:

1. Create/Update Database Records
receiving and decrypting update data from clearinghouse subsystem, drug provider subsystem, and insurance provider, as well as the patient or other health care professional or facility 413; and
updating appropriate prescription entry subsystem databases 414 with the received update data.

2. Capture New Prescription Record and Issue New Prescription
the prescriber/source of data being input to the prescription entry subsystem is authenticated by the system 400;
a prescriber enters a known patient ID 401 or scans for one 402 in a display;
the prescriber enters a drug ID, if known, or searches for a drug based on selection criteria provided by the prescriber 403;
the prescription entry subsystem displays patient use and sensitivities, drug interactions with other drugs being used by patient, drug characteristics, drug sources, generics for the drug, and substitutes for the drug 404;
the prescriber selects a drug, a drug provider, and inputs constraints on the prescription such as dosage, number of renewals, size of drug dispensed, and number of drug dispensed 405; and
the system enters the pending prescription into at least the patient's database record, and, in an alternative embodiment, into any of the prescription database, the drug provider database, and the drug database, along with pending status; encrypts and sends the prescription to a clearinghouse subsystem 406, or, in an alternative embodiment, the system prints out a paper drug prescription for the patient to take to a drug provider, such as a pharmacy, to have the paper drug prescription filled 407.

3. Renewal of an Existing Prescription
the prescriber enters a known prescription ID 408 and either renews it 412 or denies renewal 410; and
the pending renewal status of the prescription is entered in the appropriate databases 411 414; and
the prescription is encrypted and forwarded to an authenticated drug provider subsystem 415, or, in an alternative embodiment, is printed out for the patient to take to a drug provider, such as a pharmacy, to have the paper drug prescription filled 407.
   For security purposes, only authorized user are allowed access to these databases and access mechanisms are regularly changed to further protect data from unauthorized user access

FIG. 5 illustrates an exemplary configuration of a handheld prescription entry device 500 consistent with the present invention. Since only a limited amount of information can be displayed on a handheld device, in a preferred embodiment a digest of the pertinent information is displayed that is particularized to each record displayed. For example, FIG. 5 shows a prescription history for a given patient 505 obtained by entering the patient's ID or by selecting a patient list 501, and a given prescription can be selected by highlighting or picking with an input scribe and selecting new/renewal prescription 502. A list of insurers can be obtained by selecting insurer list 503 and a list of drugs by selecting drug list 504. The selections available are presented by way of example only and do not imply any limitation thereto. Databases on the handheld device are updated, for example, by resyncing a personal digital assistant with the PC 100. To protect patients' privacy all transmissions to and from the handheld device are encrypted and access to patient records is secured, e.g., by a prescriber key such as a password stored on a memory device inserted into the handheld that is regularly updated.

FIG. 6 illustrates exemplary components of a clearinghouse subsystem consistent with the present invention. The clearinghouse subsystem is accessed via a network interface 104 to a network 160, such as the Internet, in a preferred embodiment. New and renewal prescription requests are decrypted and processed by the control processor 107, the control processor accesses clearinghouse databases 141 to determine if the requested prescription or renewal is allowed by any insurance carried by the patient, and stores the resulting authorization or denial in appropriate clearinghouse databases 141 while informing the prescriber and patient via encrypted transmissions. For security purposes, only authorized user are allowed access to these databases and access mechanisms are regularly changed to further protect data from unauthorized user access

FIG. 7 illustrates exemplary databases 141 stored in the clearinghouse subsystem 140 of FIG. 5 consistent with the present invention. Database records 141 typically comprise, in a preferred embodiment:
patient database 101.4 having records identified by patient ID 301 and storing patient information 302;
drugs database 101.2 having records identified by drug ID and storing drug characteristics information 315;
insurance database 101.3 having records identified by insurance ID storing insurance coverage records 311;
prescription database 101.5 having records identified by prescription ID storing prescription details; and
drug provider (dispenser) 101.1 having records identified by prescription ID storing drug provider records.

FIG. 8 is a flow chart that illustrates exemplary system processing of a clearinghouse subsystem consistent with the present invention. In a preferred embodiment, all incoming data is decrypted and authenticated as to source. While only three processing flows are illustrated this is not to be construed as limiting as the three flows are presented as examples only, and not in any limiting sense. The processing flows accomplished by a clearinghouse subsystem comprise:

1. Create/Update Database Records
authenticating the transmission source of received data 800;
receiving and decrypting update data from prescription entry subsystem, drug provider subsystem, and insurance provider, as well as the patient or other health care professional or facility and authenticating the individual update source 801; and
updating appropriate clearinghouse databases 804 with the received update data.

2. Receive and Process New Prescription Record
a request for a new prescription is received over a network 802 and decrypted, which network is the Internet in a preferred embodiment;
the clearinghouse subsystem determines if the patient is covered by insurance 805;
if the patient has drug insurance coverage, the clearinghouse subsystem determines whether or not the requested prescription is covered by insurance 810;
if covered by insurance the requested prescription status is changed to authorized and the prescription is encrypted and forwarded over a network to a drug provider subsystem 808, or in an alternative embodiment, is printed out to be taken by the patient to a drug provider 812;
if the prescription is not covered by insurance the requested prescription status is changed to not authorized for insurance coverage; and
the prescription entry subsystem enter the prescription and its status into at least the patient's database record, and possibly as well into any of the prescription database, the drug provider database, and the drug database along with status and encrypts and sends the prescription to a clearinghouse subsystem 813.

3. Renewal of an Existing Prescription
the clearinghouse subsystem receives and decrypts a renewal request 803 and updates the appropriate clearinghouse databases 141;
the clearinghouse subsystem determines whether the renewal is authorized based on existing patient records 806;
the prescription is encrypted and forwarded to a drug provider subsystem 808, or, in an alternative embodiment, is printed out for the patient to take to a drug provider, such as a pharmacy, to get it filled 812;
the system enters the prescription and its renewal status into at least the patient's database record, and possibly as well into any of the prescription database, the drug provider database, and the drug database along with authorized or non-authorized status; and sends
if authorized, the renewal prescription is encrypted and sent to a drug provider for dispensing 808, or, in an alternative embodiment, is printed out for the patient to take to a drug provider (pharmacy) to have the paper drug prescription filled 812.
   For security purposes, only authorized user are allowed access to these databases and access mechanisms are regularly changed to further protect data from unauthorized user access

FIG. 9 illustrates exemplary components of a drug provider subsystem consistent with the present invention. The drug provider subsystem is accessed via a network interface 104 to a network 160, such as the Internet, in a preferred embodiment. Encrypted authorized new and renewal prescription requests received over the network or, in an alternative embodiment, manually input 901 from a patient provided prescription form, are decrypted (if necessary) and processed by the control processor 107, the control processor accesses drug provider databases 121 to store the authorized prescription data while informing the prescriber and patient that the prescription has been filled 902. The control processor prints out a prescription label and prescription information for the patient 900. For security purposes, only authorized user are allowed access to these databases and access mechanisms are regularly changed to further protect data from unauthorized user access

FIG. 10 illustrates exemplary databases 121 stored in drug provider subsystem 120 of FIG. 9 consistent with the present invention. In a preferred embodiment, the drug provider databases 121 are stored in encrypted form and comprise:
drug provider (dispenser) 101.1 having records identified by prescription ID storing drug provider records;
drugs database 101.2 having records identified by drug ID and storing drug characteristics information 315;
insurance database 101.3 having records identified by insurance ID storing insurance coverage records 311;
patient database 101.4 having records identified by patient ID 301 and storing patient information 302;
prescription database 101.5 having records identified by prescription ID storing prescription details; and
drug supplier database 121.1 having records identified by supplier ID storing drug supplier records.

FIG. 11 is a flow chart that illustrates exemplary system processing of a drug provider subsystem consistent with the present invention. The processing flows accomplished by a drug provider computer system comprise:

1. Create/UTpdate Database Records
receiving and decrypting update data from prescriber, drug provider, and insurance provider, as well as the patient or other health care professional or facility 1101; and
authenticating prescriber, drug provider, insurance provider, patient, or other health care professional or facility as a source and updating appropriate clearinghouse databases 1103 with the received update data, optionally in appropriately encrypted form.

2. Receive and Process New/Renewal Prescription Record
a request for a new/renewal prescription is received over a network 1102, which is the Internet in a preferred embodiment;
the drug provider subsystem enters the prescription and its filled status into at least the patient's database record, and possibly as well into any of the prescription database, the drug provider database, and the drug database 1105;
the drug provider subsystem prints a label and drug information for the patient 1104; and
the patient, prescription entry subsystem and clearinghouse subsystem is informed with an encrypted transmission that the drug prescription has been filled 1105.

Sensitive data is encoded for security using encryption schemes prior to transmission by any or all of the subsystems. Considerations of the security of the transactions comprise:
Authentication of the prescriber;
Authentication of the provider; and
Protection of the patients' privacy.

The drug provider subsystem may perform auditing or inventorying functions based on prescription requests filled. The new/renewal requests may be directly transmitted to a drug provider subsystem, in an alternative embodiment that eliminates the function of the clearinghouse, its function being accomplished by other means at the prescription entry subsystem or by the drug provider subsystem.

In a further alternative embodiment, the interaction between the prescription entry subsystem and the drug provider subsystem generates feedback to the drug prescriber in real time, such feedback provided within a pre-determined time and comprising:
availability/out-of-stock status of particular drugs;
other drugs prescribed to the same patient, with interaction warnings; and
insurance reimbursement information about different drugs/generics.

The system and method of the present invention provide any of email or other notification (voice mail, fax, telephone call) to the patient that the prescription has been prescribed by the prescriber; and the prescription has been filled and is ready for pick-up or shipment.

In an alternative embodiment, a prescription can be held at the clearinghouse subsystem after receipt from the prescription entry subsystem, being held for one of pickup by the patient or until redirected to a drug provider subsystem, such redirection being based on the direction and choice of the patient.

While the preferred embodiments of the present invention have been illustrated and described, it will be understood by those skilled in the art that various changes and modifications may be made, and equivalents may be substituted for elements thereof without departing from the true scope of the present invention. In addition, many modifications may be made to adapt the teaching of the present invention to a particular situation without departing from its central scope. Therefore it is intended that the present invention not be limited to the particular embodiments disclosed as the best mode contemplated for carrying out the present invention, but that the present invention include all embodiments falling within the scope of the appended claims.

1. A method for delivery of a prescribed drug to a patient, comprising the steps of:
entering data for at least one of a new, renewal, and modified drug prescription for the patient by a drug prescriber;
obtaining authorization for the drug prescription from a drug insurer by one of the drug prescriber, a clearinghouse, and a current drug provider;
filling the authorized drug prescription with a prescribed drug by the current drug provider; and
delivering the prescribed drug to the patient by the current drug provider.

2. The method of claim 1, further comprising the step of providing a mobile device as an optional user interface for entering data, displaying a response, and informing.

3. The method of claim 2, wherein said filling step further comprises the steps of:
determining by the current drug provider of when the current drug provider can fill the authorized drug prescription;
informing of when the current drug provider has determined the authorized drug prescription can be filled;
in response to the informing step, receiving by the current drug provider one of a cancellation of the authorized drug prescription and a direction to fill the authorized drug prescription; and
if the drug prescription must be filled in advance of when the current drug provider determined the authorized drug prescription can be filled, repeating the filling step with another drug provider as the current drug provider.

4. The method of claim 3, wherein said informing step further comprises the step of informing within a pre-set response time.

5. The method of claim 1, further the steps of:
a sender selected from the group consisting of the drug prescriber, the clearinghouse and the current drug provider, performing the steps of -
if the patient has insurance
i. electronically transmitting the entered drug prescription data for the patient to a drug insurer by to the sender;
ii. receiving the electronically transmitted drug prescription data by the drug insurer,
iii. electronically transmitting the authorization data to the sender by the drug insurer,
iv. receiving the electronically transmitted authorization data by the sender, and
v. electronically transmitting the authorized drug prescription data to the current drug provider; and
if the patient does not have insurance, electronically transmitting the drug prescription data to the current drug provider by the sender.

6. The method of claim 5, wherein:
each said electronically transmitting step further comprises the step of first encrypting the data to be transmitted; and
each said receiving step further comprises the step of first decrypting the received data.

7. The method of claim 6, wherein:
each said electronically transmitting step further comprises transmitting over a network; and
each said electronically receiving step further comprises electronically receiving over a network,
wherein said network comprises at least one of a wireless network, an intranet (local area network) and an internet (wide area network).

8. The method of claim 5, wherein:
each said electronically transmitting step further comprises transmitting over a network; and
each said electronically receiving step further comprises electronically receiving over a network,
wherein said network comprises at least one of a wireless network, an intranet (local area network) and an internet (wide area network).

9. The method of claim 1, further comprising the steps of:
entering patient data by the drug prescriber;
performing by the drug prescriber and optionally by the clearinghouse 140 and the current drug provider the steps of -
storing entered patient data in a patient database for a new patient;
where necessary, updating patient data in the patient database for an existing patient;
storing the entered drug prescription in the patient database and a prescription database as new, refill, and modified; and
storing the insurer's authorization or denial for the drug prescription in the prescription database.

10. The method of claim 9, wherein said entering step further comprises the steps of:
providing drug characteristics from a drug database, said characteristics including at least one of dosage guidelines, generic equivalent drugs, substitute drugs, drug interactions, drug side effects, and drug actions;
determining from the provided drug characteristics an adverse drug interaction of the prescribed drug with another patient drug;
storing in said patient database the determined drug interaction by the drug prescriber 100 and optionally by the clearinghouse and the current drug provide; and
in the case of a determined adverse drug interaction, repeating the entering step to enter a new drug prescription.

11. A method for a drug provider to deliver a prescribed drug to a patient, comprising the steps of:
one of electronically and manually receiving by a drug provider at least one of a new, refill, renew and modified drug prescription for the prescribed drug from a drug requester;
optionally, authorizing the drug prescription for the patient by a drug insurer;
filling the authorized drug prescription with the prescribed drug by the drug provider; and
delivering the prescribed drug to the patient by the drug provider.

12. The method of claim 11, wherein said filling step further comprises the steps of:
determining by the drug provider of when the drug provider can fill the authorized drug prescription;
informing the drug requestor of when the drug provider can fill the authorized drug prescription; and
in response to the informing step, receiving by the drug provider from the drug requestor one of a cancellation of the authorized drug prescription and a direction to fill the authorized drug prescription.

13. The method of claim 11, wherein said drug requestor is one of the patient and the drug prescriber for a refill drug prescription and the drug prescriber for any of a new, refill, renew and modified drug prescription.

14. A method for delivery of a drug prescription to a patient, comprising the steps of:
entering data for at least one of a new, renewal, refill and modified drug prescription for the patient by a drug requestor;
optionally, obtaining authorization for the drug prescription from a drug insurer;
printing the authorized prescription; and
delivering the printed authorized prescription to the patient.

15. The method of claim 14, wherein said drug requestor is one of the patient and a drug prescriber for a refill drug prescription and the drug prescriber for any of a new, refill, renew and modified drug prescription.

16. The method of claim 14, wherein said obtaining, printing and delivering steps are performed by one of a clearinghouse and a drug provider.

17. A system for delivery of one of a drug prescription and a prescribed drug to a patient, comprising:
a prescription entry subsystem configured to provide for entry of new and update patient data and at least one of a new, renewal, refill, and modified drug prescription data for the patient by a drug requester;
a drug provider subsystem configured to interface with the prescription entry system to exchange data comprising the drug prescription and provided responses, and deliver the prescribed drug to the patient; and
optionally, including a clearinghouse subsystem configured to interface between the prescription entry subsystem 100 and the drug provider subsystem to exchange data comprising validation by the clearinghouse subsystem of the drug requester and the drug provider and provided responses.

18. The system of claim 17, wherein:
said interface is one of an intranet and an internet; and
said exchanged data is encrypted at a source subsystem and decrypted by a destination subsystem, said source and destination subsystems being any of the prescription entry subsystem, the clearinghouse subsystem, and the drug provider subsystem.

19. The system of claim 17, wherein said prescription entry subsystem further comprises a mobile device 110 as a user interface for entering data and displaying responses.

20. The system of claim 17, wherein:
each said subsystem further comprises at least a patient database and at least one of a prescription database, a drug provider database, a drug database, and an insurance database;
each said subsystem is further configured to store said entered new patient data and update patient data in the patient database, and said entered drug prescription data in the drug prescription database; and
the drug prescription entry subsystem is further configured to
provide drug characteristics from a drug database, said characteristics including at least one of dosage guidelines, generic equivalent drugs, substitute drugs, drug interactions, drug side effects, and drug actions;
determine, from the provided drug characteristics, an adverse drug interaction of the prescribed drug with another patient drug;
store the determined drug interaction in the patient database;
optionally, exchange the adverse interaction data with the clearinghouse subsystem and the drug provider subsystem for storage in their patient database.

21. The system of claim 17, wherein one of the drug provider subsystem and clearinghouse subsystem is further configured to obtain authorization of the drug prescription by a drug insurer and provide a response comprising said obtained authorization to the drug prescription entry subsystem; and
said drug provider subsystem is further configured to only deliver the prescribed drug for an authorized drug prescription.

22. The system of claim 21, wherein one of the drug prescription entry subsystem and clearinghouse subsystem is further configured to print an authorized drug prescription for pickup by a patient.
